(19) United States
(12) Patent Application Publication
(10) Pub. No.: US 2016/0349436 A1
(43) Pub. Date: Dec. 1, 2016

(54) LIGHT SOURCE MODULES AND THE BACKLIGHT MODULES WITH THE LIGHT SOURCE MODULE

(71) Applicant: SHENZHEN CHINA STAR OPTOELECTRONICS TECHNOLOGY CO., LTD., Shenzhen, Guangdong (CN)

(72) Inventor: Yanxue ZHANG, Shenzhen, Guangdong (CN)

(73) Assignee: Shenzhen China Star Optoelectronics Technology, Shenzhen, Guangdong (CN)

(21) Appl. No.: 14/423,106

(22) PCT Filed: Jan. 13, 2015
(86) PCT No.: PCT/CN2015/070637

§ 371 Date: Feb. 20, 2015

(30) Foreign Application Priority Data
Dec. 31, 2014 (CN) 201410854622.0

(51) Int. Cl. F21V 8/00; G02F 1/1335

(52) U.S. Cl. CPC G02B 6/0021; G02B 6/0043; G02F 1/133603

(57) ABSTRACT

A light source module is disclosed. The light source includes: a power supply board; a plurality of LED chips arranged on a surface of the power supply board in a matrix; and a light guiding housing arranged above the power supply board, a bottom surface of the light guiding housing is bonded with a surface of the power supply board so as to encapsulate the LED chips between the light guiding housing and the power supply board. In addition, a backlight module including the light source module is also disclosed. The LED chips are mounted on the surface of the power supply board, and a light reflection layer is coated on the surface. The power supply board is integrated with the light guiding housing above the LED chip to form an integral light module so as to enhance the ratio of the visible area of the liquid crystal device.

### BACKGROUND OF THE INVENTION

1. Field of the Invention

The present disclosure relates to liquid crystal display technology, and more particularly to a light source module for enhancing a ratio of the visible area and the backlight module with the light source module.

2. Discussion of the Related Art

LCDs are characterized by attributes such as thinner, power-saving, and low radiation, and thus are widely adopted by electronic devices such as notebooks, mobile phones, and electrical dictionaries. Usually, the LCDs include a liquid crystal panel and a backlight module arranged opposite to the liquid crystal panel. As the liquid crystal panel is not capable of emitting the light itself, it is needed to adopt the backlight module for providing the backlight so as to display images.

Currently, among the mobile products, backlight sources adopted by the backlight module may mount the LED chips on flexible circuit boards to form light strings. With respect to such light source, it is not feasible to obtain a full-screen light source as there are both a lighting area and a mixed light area. FIG. 1 is a schematic view of the display panel 1 corresponding to one conventional backlight source. The defects of the conventional backlight source may results in a display area la and a non-display area lb. However, as the screen ratio of the electronic device has been increased, a ratio of the visible area of the display panel 1, which is the ratio of the display area la to the display panel 1, is the development bottleneck of such products.

### SUMMARY

According to the present disclosure, a power supply board and a light guiding housing are integrated. In addition, LED chips mounted on a surface of the power supply board are encapsulated in the light source module and the backlight module having the light source module. The light source module and the backlight module having the light source module are arranged between the power supply board and the light guiding housing. In this way, the ratio of the visible area of the liquid crystal device is enhanced.

In one aspect, a light source module includes: a power supply board ; a plurality of LED chips arranged on a surface of the power supply board in a matrix; and a light guiding housing arranged above the power supply board, a bottom surface of the light guiding housing is bonded with a surface of the power supply board so as to encapsulate the LED chips between the light guiding housing and the power supply board.

Wherein the bottom surface of the light guiding housing further includes a plurality of grooves for receiving the LED chips.

Wherein the surface of the power supply board includes a light reflection layer.

Wherein a plurality of dots are arranged on a top surface of the light guiding housing.

Wherein the power supply board is a Printed Circuit Board (PCB).

In another aspect, a backlight module includes: a back frame, a plastic frame, and a light source module, the light source module being arranged within the back frame, and the plastic frame being arranged between a side wall of the back frame and a lateral surface of the light source module. The light source module includes: a power supply board arranged above a bottom plate of the back frame; a plurality of LED chips arranged on a surface of the power supply board in a matrix; and a light guiding housing arranged above the power supply board, a bottom surface of the light guiding housing is bonded with a surface of the power supply board so as to encapsulate the LED chips between the light guiding housing and the power supply board.

Wherein the bottom surface of the light guiding housing further includes a plurality of grooves for receiving the LED chips.

Wherein the surface of the power supply board includes a light reflection layer.

Wherein a plurality of dots are arranged on a top surface of the light guiding housing.

Wherein the power supply board is a Printed Circuit Board (PCB).

In view of the above, the LED chips are mounted on the surface of the power supply board. Afterward, a light reflection layer is coated on the surface. The power supply board is integrated with the light guiding housing above the LED chip to form an integral light module so as to enhance the ratio of the visible area of the liquid crystal device.

### BRIEF DESCRIPTION OF THE DRAWINGS

FIG. 1 is a schematic view of the display area of the display panel corresponding to one conventional backlight source.

FIG. 2 is a schematic view of the backlight module in accordance with one embodiment.

FIG. 3 is a cross section view of the light source module in accordance with one embodiment.

FIG. 4 is a top view of the light guiding housing in accordance with one embodiment.

FIG. 5 is a schematic view of the display panel corresponding to the backlight module in accordance with one embodiment.

### DETAILED DESCRIPTION OF THE EMBODIMENTS

Various example embodiments will now be described more fully with reference to the accompanying drawings in which some example embodiments are shown. In the drawings, the thicknesses of layers and regions may be exaggerated for clarity. In the following description, in order to avoid the known structure and/or function unnecessary detailed description of the concept of the invention result in confusion, well-known structures may be omitted and or functions described in unnecessary detail.

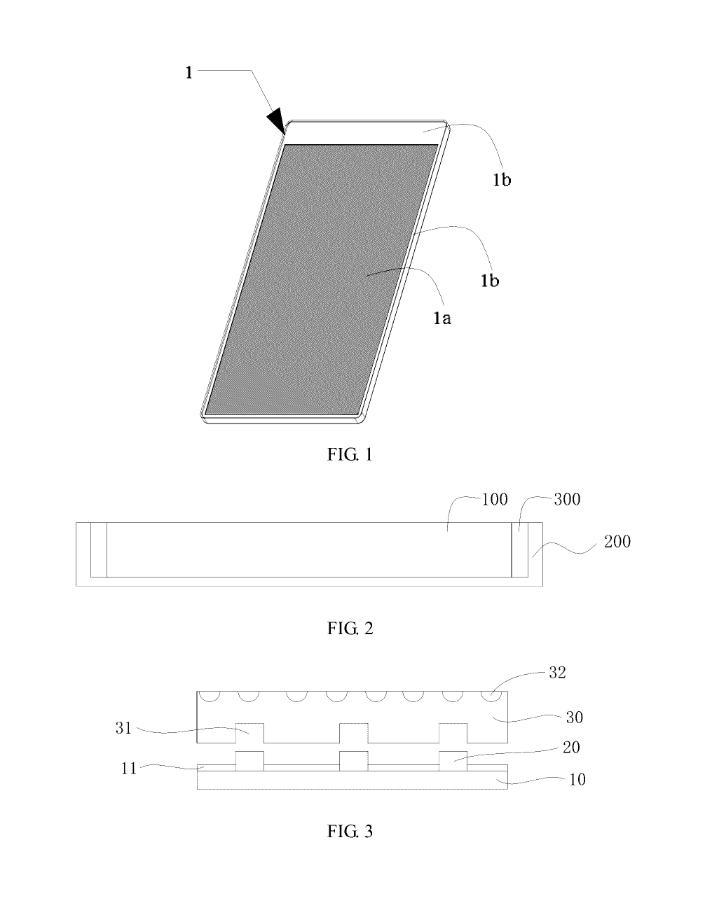

FIG. 2 is a schematic view of the backlight module in accordance with one embodiment.

Referring to FIG. 2, the backlight module includes a light source module 100, a back frame 200 for supporting the light source module 100, and a plastic frame 300 clasped between a side wall of the back frame 200 and a lateral surface of the light source module 100. That is, the light source module 100 is arranged within the back frame 200.

The plastic frame 300 is configured for fixing the light source module 100 so as to prevent the light source module 100 and the back frame 200 from being damaged due to collision.

FIG. 3 is a cross section view of the light source module in accordance with one embodiment.

Referring to FIG. 3, the light source module 100 includes a power supply board 10 and a light guiding housing 30 arranged above the power supply board 10. A plurality of LED chips 20 are arranged on a surface of the power supply board 10 in a matrix. A bottom surface of the light guiding housing 30 is bonded with a surface of the power supply board 10 so as to encapsulate the LED chips 20 between the light guiding housing 30 and the power supply board 10.

In the embodiment, the bottom surface of the light guiding housing 30 further includes a plurality of grooves 31 for receiving the LED chips 20. In this way, the light guiding housing 30 and the power supply board 10 may be closely bonded to form the light source module 100. In addition, the surface of the power supply board 10 further includes a light reflection layer 11 for enhancing reflection effect of light beams emitted by the LED chips 20. That is, the light reflection layer 11 is coated on the surface of the power supply board 10 facing toward the light guiding housing 30.

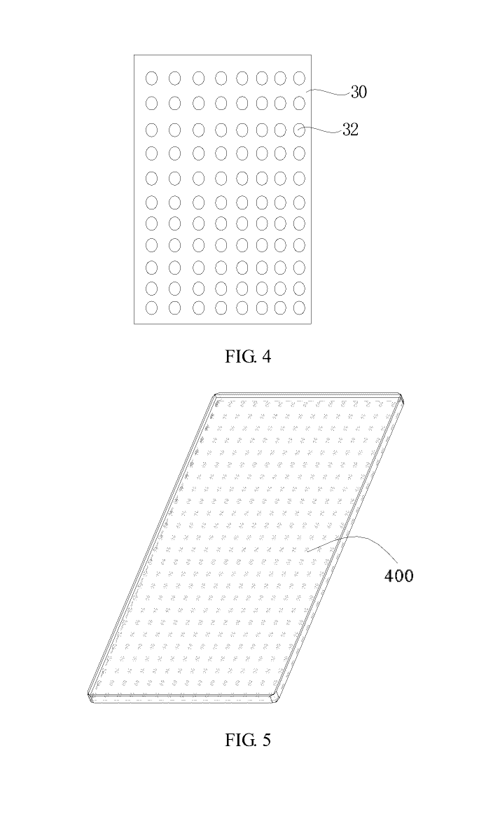

In order to enhance the visual effects, a certain distance is configured between the LED chips 20 on the power supply board 10. Thus, a plurality of dots 32 are arranged on a top surface of the light guiding housing 30. The configuration of the dots 32 may result in more uniform light beams emitted from the top surface of the light guiding housing 30. FIG. 4 is a top view of the light guiding housing 30 in accordance with one embodiment.

Preferably, the power supply board 10 may be a Printed Circuit Board (PCB). The LED chips 20 may be directly mounted on the surface of the power supply board 10.

FIG. 5 is a schematic view of the display panel corresponding to the backlight module in accordance with one embodiment.

Comparing to the display area la of the display panel 1 of the backlight source of FIG. 1, the display panel 400 may display in a full-screen so as to enhance the ratio of the visible area.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A light source module, comprising:
a power supply board ;
a plurality of LED chips arranged on a surface of the power supply board in a matrix; and
a light guiding housing arranged above the power supply board, a bottom surface of the light guiding housing is bonded with a surface of the power supply board so as to encapsulate the LED chips between the light guiding housing and the power supply board.

2. The light source module as claimed in claim 1, wherein the bottom surface of the light guiding housing further comprises a plurality of grooves for receiving the LED chips.

3. The light source module as claimed in claim 1, wherein the surface of the power supply board comprises a light reflection layer.

4. The light source module as claimed in claim 1, wherein a plurality of dots are arranged on a top surface of the light guiding housing.

5. The light source module as claimed in claim 1, wherein the power supply board is a Printed Circuit Board (PCB).

6. The light source module as claimed in claim 2, wherein the power supply board is a PCB.

7. The light source module as claimed in claim 3, wherein the power supply board is a PCB.

8. The light source module as claimed in claim 4, wherein the power supply board is a PCB.

9. A backlight module, comprising:
a back frame, a plastic frame, and a light source module, the light source module being arranged within the back frame, and the plastic frame being arranged between a side wall of the back frame and a lateral surface of the light source module, the light source module comprises:
a power supply board arranged above a bottom plate of the back frame;
a plurality of LED chips arranged on a surface of the power supply board in a matrix; and
a light guiding housing arranged above the power supply board, a bottom surface of the light guiding housing is bonded with a surface of the power supply board so as to encapsulate the LED chips between the light guiding housing and the power supply board.

10. The light source module as claimed in claim 9, wherein the bottom surface of the light guiding housing further comprises a plurality of grooves for receiving the LED chips.

11. The light source module as claimed in claim 9, wherein the surface of the power supply board comprises a light reflection layer.

12. The light source module as claimed in claim 9, wherein a plurality of dots are arranged on a top surface of the light guiding housing.

13. The light source module as claimed in claim 9, wherein the power supply board is a Printed Circuit Board (PCB).

14. The light source module as claimed in claim 10, wherein the power supply board is a PCB.

15. The light source module as claimed in claim 11, wherein the power supply board is a PCB.

16. The light source module as claimed in claim 12, wherein the power supply board is a PCB.
